(19) United States
(12) Patent Application Publication
(10) Pub. No.: US 2023/0370973 A1
(43) Pub. Date: Nov. 16, 2023

(54) ADAPTIVE SELECTION OF A SLEEP PROCEDURE IN A WIRELESS COMMUNICATIONS SYSTEM

(71) Applicant: QUALCOMM Incorporated, San Diego, CA (US)

(72) Inventors: Arvind Vardarajan Santhanam, San Diego, CA (US); Scott Hoover, Del Mar, CA (US); Joshua Tennyson Macdonald, Superior, CO (US); Yash Pathak, Erie, CO (US); Omkar Reddy Seelam, Westminster, CO (US); Mona Agrawal, San Diego, CA (US)

(21) Appl. No.: 17/745,122

(22) Filed: May 16, 2022

(51) Int. Cl. H04W 52/02; H04W 68/00

(52) U.S. Cl. CPC H04W 52/0274; H04W 68/005

(57) ABSTRACT

Methods, systems, and devices for wireless communications are described. The method may include the user equipment (UE) selecting, based at least in part on an operating characteristic for the UE, a procedure for entering a sleep mode from among a set of procedures for entering the sleep mode. The set of procedure may include a first procedure and a second procedure. Upon selecting the procedure, the UE may monitor for page signaling for the UE during a time period and perform the selected procedure for entering the sleep mode.

### FIELD OF TECHNOLOGY

The following relates to wireless communications, including adaptive selection of a sleep procedure in a wireless communications system.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some examples, to save power during periods of inactivity a UE may enter a sleep mode. During the sleep mode, the UE may deactivate or power down one or more components. For example, the UE may deactivate or power down baseband circuitry of the UE.

### SUMMARY

The described techniques relate to improved methods, systems, devices, and apparatuses that support adaptive selection of a sleep procedure in a wireless communications system. For example, the described techniques provide for a user equipment (UE) to select a sleep procedure based on one or more operating metrics of the UE. As an example, the method disclosed herein may include the UE selecting a procedure for entering a sleep mode from a set of procedures including at least a first procedure and a second procedure. In some examples, the one or more metrics may include a statistic associated with the UE receiving page signaling intended for the UE, a statistic associated with the UE receiving page signaling not intended for the UE, a power capability of the UE, a connectivity mode associated with the UE, or a duration associated with a discontinuous reception (DRX) cycle configured for the UE. Upon selecting the procedure, the UE may monitor for page signaling from a network entity (e.g., a base station) and perform the selected procedure. The first procedure may include deactivating baseband circuitry immediately after monitoring for the page signaling (e.g., a first duration after monitoring for the page signaling). The second procedure may include deactivating baseband circuitry a second duration after monitoring for the page signaling. The second duration may be longer than the first duration and during the second duration, the UE may attempt to decode the page signaling received from the network entity.

A method for wireless communication at a UE is described. The method may include selecting, based on one or more operating characteristics for the UE, a procedure for entering a sleep mode from among a set of procedures for entering the sleep mode, where the set of procedures includes a first procedure for entering the sleep mode and a second procedure for entering the sleep mode, monitoring, after selecting the procedure for entering the sleep mode, for page signaling for the UE during a time period, performing the selected procedure for entering the sleep mode, where, the first procedure for entering the sleep mode includes deactivating baseband circuitry of the UE a first duration after the time period, and the second procedure for entering the sleep mode includes deactivating the baseband circuitry of the UE a second duration after the time period, the second duration longer than the first duration.

An apparatus for wireless communication at a UE is described. The apparatus may include a memory, a transceiver, and at least one processor of the UE, the at least one processor coupled with the memory and the transceiver. The at least one processor may be configured to select, based on one or more operating characteristics for the UE, a procedure for entering a sleep mode from among a set of procedures for entering the sleep mode, where the set of procedures includes a first procedure for entering the sleep mode and a second procedure for entering the sleep mode, monitor, after selecting the procedure for entering the sleep mode, for page signaling for the UE during a time period, perform the selected procedure for entering the sleep mode, where, the first procedure for enter the sleep mode includes deactivating baseband circuitry of the UE a first duration after the time period, and the second procedure for enter the sleep mode includes deactivating the baseband circuitry of the UE a second duration after the time period, the second duration longer than the first duration.

Another apparatus for wireless communication at a UE is described. The apparatus may include means for selecting, based on one or more operating characteristics for the UE, a procedure for entering a sleep mode from among a set of procedures for entering the sleep mode, where the set of procedures includes a first procedure for entering the sleep mode and a second procedure for entering the sleep mode, means for monitoring, after selecting the procedure for entering the sleep mode, for page signaling for the UE during a time period, means for performing the selected procedure for entering the sleep mode, where, means for the first procedure for entering the sleep mode includes deactivating baseband circuitry of the UE a first duration after the time period, and means for the second procedure for entering the sleep mode includes deactivating the baseband circuitry of the UE a second duration after the time period, the second duration longer than the first duration.

A non-transitory computer-readable medium storing code for wireless communication at a UE is described. The code may include instructions executable by a processor to select, based on one or more operating characteristics for the UE, a procedure for entering a sleep mode from among a set of procedures for entering the sleep mode, where the set of procedures includes a first procedure for entering the sleep mode and a second procedure for entering the sleep mode, monitor, after selecting the procedure for entering the sleep mode, for page signaling for the UE during a time period, perform the selected procedure for entering the sleep mode, where, the first procedure for enter the sleep mode includes deactivating baseband circuitry of the UE a first duration after the time period, and the second procedure for enter the sleep mode includes deactivating the baseband circuitry of the UE a second duration after the time period, the second duration longer than the first duration.

In some examples of the method, apparatuses, and non-transitory computer-readable medium described herein, the one or more operating characteristics include a statistic associated with receiving page signaling intended for the UE, a statistic associated with receiving page signaling not intended for the UE, a connectivity mode associated with the UE, a power capability of the UE, a rate of power consumption for the UE, a duration associated with a DRX configured for the UE, or any combination thereof.

In some examples of the method, apparatuses, and non-transitory computer-readable medium described herein, the statistic associated with receiving page signaling intended for the UE includes a fraction, the fraction indicating a number of times the UE received page signaling intended for the UE over a number of time periods.

In some examples of the method, apparatuses, and non-transitory computer-readable medium described herein, the statistic associated with receiving the page signaling not intended for the UE includes a fraction, the fraction indicating a number of times the UE received page signaling not intended for the UE over a number of time periods.

Some examples of the method, apparatuses, and non-transitory computer-readable medium described herein may further include operations, features, means, or instructions for determining whether a statistic associated with receiving page signaling intended for the UE may be above a first threshold, whether a statistic associated with receiving page signaling not intended for the UE may be below a second threshold, or both, where selecting the procedure for entering the sleep mode based on the one or more operating characteristics for the UE includes and selecting the second procedure for entering the sleep mode based on determining that the statistic associated with receiving page signaling intended for the UE may be above the first threshold, that the statistic associated with receiving page signaling not intended for the UE may be below the second threshold, or both.

Some examples of the method, apparatuses, and non-transitory computer-readable medium described herein may further include operations, features, means, or instructions for determining whether the UE communicates, within a second time period, more data via one or more cellular connections than one or more non-cellular connections, where selecting a procedure for entering the sleep mode based on the one or more operating characteristics for the UE may include operations, features, means, or instructions for selecting the second procedure for entering the sleep mode based on determining that the UE communicates, within the second time period, more data via the one or more cellular connections than the one or more non-cellular connections.

Some examples of the method, apparatuses, and non-transitory computer-readable medium described herein may further include operations, features, means, or instructions for determining whether a power capability of the UE satisfies a condition, where selecting the procedure for entering the sleep mode based on the one or more operating characteristics for the UE may include operations, features, means, or instructions for selecting the second procedure for entering the sleep mode based on determining that the power capability of the UE satisfies the condition.

In some examples of the method, apparatuses, and non-transitory computer-readable medium described herein, determining whether the power capability of the UE satisfies the condition may include operations, features, means, or instructions for determining whether a battery level associated with the UE may be above a threshold and determining whether the UE may be connected to an alternating current adapter.

Some examples of the method, apparatuses, and non-transitory computer-readable medium described herein may further include operations, features, means, or instructions for determining whether a duration associated with a DRX configured for the UE satisfies a threshold, where selecting the procedure for entering the sleep mode based on the one or more operating characteristics for the UE may include operations, features, means, or instructions for selecting the first procedure for entering the sleep mode based on determining that the duration associated with the DRX configured for the UE satisfies the threshold.

Some examples of the method, apparatuses, and non-transitory computer-readable medium described herein may further include operations, features, means, or instructions for determining whether a rate of power consumption for the UE satisfies a threshold, where selecting the procedure for entering the sleep mode based on the one or more operating characteristics for the UE may include operations, features, means, or instructions for selecting the second procedure for entering the sleep mode based on determining that the rate of power consumption for the UE satisfies the threshold.

In some examples of the method, apparatuses, and non-transitory computer-readable medium described herein, the selected procedure for entering the sleep mode includes the second procedure and the method, apparatuses, and non-transitory computer-readable medium may include further operations, features, means, or instructions for attempting to decode the page signaling during at least a portion of the second duration, where deactivating the baseband circuitry may be based on failing to decode the page signaling during at least the portion of the second duration.

In some examples of the method, apparatuses, and non-transitory computer-readable medium described herein, the selected procedure for entering the sleep mode includes the first procedure and the method, apparatuses, and non-transitory computer-readable medium may include further operations, features, means, or instructions for attempting to decode the page signaling after deactivating the baseband circuitry.

### BRIEF DESCRIPTION OF THE DRAWINGS

FIGS. 1 and 2 illustrate examples of a wireless communications system that supports adaptive selection of a sleep procedure in a wireless communications system in accordance with one or more aspects of the present disclosure.

FIGS. 3A and 3B illustrate examples of a sleep procedure that supports adaptive selection of a sleep procedure in a wireless communications system in accordance with one or more aspects of the present disclosure.

FIG. 4 illustrates an example of a flow diagram that supports adaptive selection of a sleep procedure in a wireless communications system in accordance with one or more aspects of the present disclosure.

FIG. 5 illustrates an example of a process flow that supports adaptive selection of a sleep procedure in a wireless communications system in accordance with one or more aspects of the present disclosure.

FIGS. 6 and 7 show block diagrams of devices that support adaptive selection of a sleep procedure in a wireless communications system in accordance with one or more aspects of the present disclosure.

FIG. 8 shows a block diagram of a communications manager that supports adaptive selection of a sleep procedure in a wireless communications system in accordance with one or more aspects of the present disclosure.

FIG. 9 shows a diagram of a system including a device that supports adaptive selection of a sleep procedure in a wireless communications system in accordance with one or more aspects of the present disclosure.

FIGS. 10 through 12 show flowcharts illustrating methods that support adaptive selection of a sleep procedure in a wireless communications system in accordance with one or more aspects of the present disclosure.

### DETAILED DESCRIPTION

In some examples, a user equipment (UE) may enter a sleep mode to conserve power. Entering the sleep mode may refer to powering down or deactivating baseband processing of the UE. In some examples, the UE may be configured with a procedure for entering the sleep mode. The procedure may include one of an aggressive sleep flow or a conservative sleep flow. If the UE is configured with the aggressive sleep flow, the UE may enter the sleep mode immediately after a paging opportunity. If the UE is configured with the conservative sleep flow, the UE may enter a sleep mode a duration after the paging opportunity and during the duration, the UE may attempt to decode page signaling received at the UE. In some examples, the UE configured to use the aggressive sleep flow may consistently receive page signaling intended for the UE. However, because the UE may enter the sleep mode before decoding the page signaling, the UE may perform a wake up procedure before transmitting or receiving signaling in response to the page signaling intended for the UE which may increase power consumption and latency at the UE. As such, it may be beneficial for the UE to switch between different procedures for entering a sleep mode.

As described herein, a UE may select a procedure for entering the sleep mode from a set of procedures for entering the sleep mode based on operating metrics associated with the UE. In some examples, the set of procedures may include the aggressive sleep flow and the conservative sleep flow and the operating metrics may include a statistic associated with the UE receiving page signaling intended for the UE, a statistic associated with the UE receiving page signaling not intended for the UE, a power capability of the UE, or a connectivity mode of the UE. In one example, the UE may select the conservative sleep flow if the UE is not power constrained, if the UE primarily uses a cellular connection to communicate data, if power consumption due to the conservative sleep flow is negligible, if the statistic associated with the UE receiving page signaling intended for the UE is above a threshold, or if the statistic associated with the UE receiving page signaling not intended for the UE is below a threshold. Using the operating metrics may allow the UE to select a procedure for entering a sleep mode based on current conditions which may reduce power consumption at the UE.

Aspects of the disclosure are initially described in the context of wireless communications systems. Additional aspects of the disclosure are described in the contexts of sleep procedures, a flow diagram, and a process flow. Aspects of the disclosure are further illustrated by and described with reference to apparatus diagrams, system diagrams, and flowcharts that relate to adaptive selection of a sleep procedure in a wireless communications system.

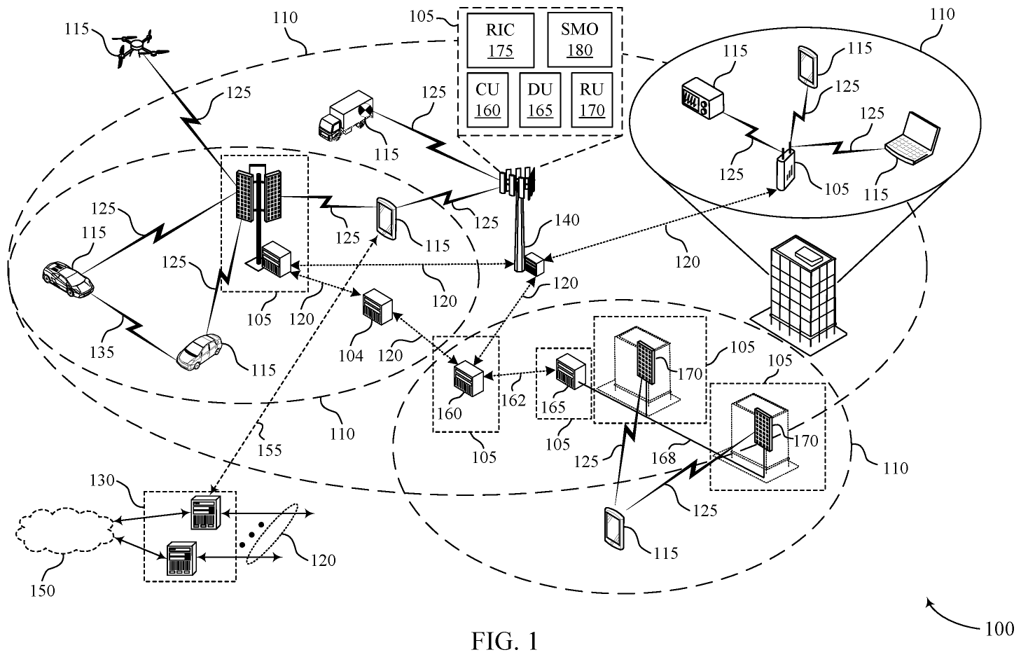

FIG. 1 illustrates an example of a wireless communications system 100 that supports adaptive selection of a sleep procedure in a wireless communications system in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 over an interface (e.g., a backhaul link). IAB donor and IAB nodes 104 may communicate over an F1 interface according to a protocol that defines signaling messages (e.g., an F1 AP protocol). Additionally, or alternatively, the CU 160 may communicate with the core network over an interface, which may be an example of a portion of backhaul link, and may communicate with other CUs 160 (e.g., a CU 160 associated with an alternative IAB donor) over an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, and referred to as a child IAB node associated with an IAB donor. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support adaptive selection of a sleep procedure in a wireless communications system as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

As described herein, a UE 115 may select a sleep procedure based on one or more operating metrics of the UE 115. As an example, the method may include the UE 115 selecting a procedure for entering a sleep mode from a set of procedures including at least a first procedure and a second procedure. In some examples, the one or more metrics may include a statistic associated with the UE 115 receiving page signaling intended for the UE 115, a statistic associated with the UE 115 receiving page signaling not intended for the UE 115, a power capability of the UE 115, a connectivity mode associated with the UE 115, or a duration associated with a discontinuous reception (DRX) cycle configured for the UE 115. Upon selecting the procedure, the UE 115 may monitor for page signaling from a network entity (e.g., a base station) and perform the selected procedure. The first procedure may include deactivating baseband circuitry immediately after monitoring for the page signaling (e.g., a first duration after monitoring for the page signaling). The second procedure may include deactivating baseband circuitry a second duration after monitoring for the page signaling. The second duration may be longer than the first duration and during the second duration, the UE 115 may attempt to decode the page signaling received from the network entity.

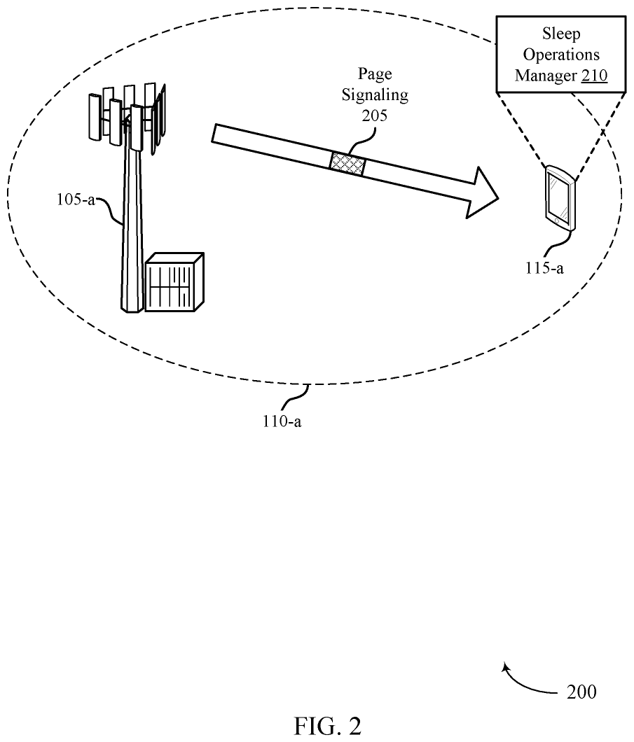

FIG. 2 illustrates an example of a wireless communications system 200 that supports adaptive selection of a sleep procedure in a wireless communications system in accordance with one or more aspects of the present disclosure. In some examples, the wireless communications system 200 may implement aspects of a wireless communications system 100. For example, the wireless communications system 200 may include a base station 105-a and a UE 115-a which may be examples of a network entity 105 and a UE 115 as described with reference to FIG. 1. In some examples, the base station 105-a and the UE 115-a may be located in a coverage area 110-a.

In some examples, there may be periods of time where there is no traffic occurring between the UE 115-a and the base station 105-a. During these periods of time, keeping all of the components at the UE 115-a powered on may unnecessarily consume power. To reduce unnecessary power consumption, the UE 115-a may implement DRX. DRX may be described as a periodic repetition of a wake up mode and a sleep mode. During the sleep mode, the UE 115-a may power off one or more components. An example of the one or more components that may be powered off in an effort to save power may be baseband circuitry (e.g., an antenna, an amplifier, a filter, a tuner, or a detector of the UE 115-a). Baseband circuitry may be responsible for receiving and transmitting radio signals.

In some examples, there may be different procedures for entering the sleep mode during a DRX cycle. For example, a first procedure may be known as a conservative flow. When configured to the use the first procedure, the UE 115-a may monitor for page signaling (e.g., physical downlink control channel (PDCCH) transmissions) during a first duration (e.g., a paging opportunity) and stay awake (e.g., keep baseband circuitry powered on) for a second duration after the first duration. During the second duration, the UE 115-a may attempt to decode the page signaling. The UE 115-a may be able to decode and interpret the page signaling if the page signaling is intended for the UE 115-a (and not another UE 115). The UE 115-a may determine whether the page signaling is intended for the UE 115-a by looking at an identifier addressed to the page signaling. An example of the identifier may be an NG-5G-S-TMSI which may include an AMF Set ID, an AMF pointer, and a 5G-TMSI. If the identifier matches the identifier configured for (e.g., assigned to) the UE 115-a, the UE 115-a may determine the page signaling is intended for the UE 115-a. If the UE 115-a is able to decode and interpret the page signaling, the UE 115-a may stay awake (e.g., keep baseband circuitry powered on) after the second duration such that the UE 115-a may transmit or receive subsequent signaling. If the UE 115-a is unable to decode the page signaling, the UE 115-a may enter the sleep mode after the second duration and until the next DRX cycle.

Additionally, the UE 115-a may implement a second procedure known as an aggressive flow. When configured to use the second procedure, the UE 115-a may monitor for page signaling from the base station 105-a during the first duration (e.g., the paging opportunity) and enter sleep immediately after the first duration (e.g., after a third duration shorter than the second duration). Although the UE 115-a is in the sleep mode, the UE 115-a may attempt to decode and interpret the page signaling. However, if the UE 115-a determines the page signaling is intended for the UE 115-a, the UE 115-a may abort sleep and undergo a wake up procedure in order to receive or transmit subsequent signaling. Aborting sleep and undergoing the wake up procedure may increase latency at the UE 115-a (e.g., 11 ms). If the UE 115-a is unable to decode and interpret the page signaling, the UE 115-a may stay asleep (e.g., keep baseband circuitry powered off) until the next DRX cycle. The UE 115-a may be configured to use one of the different procedures for entering the sleep mode (e.g., the first procedure or the second procedure) during the DRX cycle. However, a rate of traffic between the UE 115-a and the base station 105-a may change over time and a single procedure may not be beneficial for all rates of traffic that the UE 115-a encounters. For example, if the UE 115-a switches form receiving page signaling inconsistently (e.g., low traffic rate) to receiving page signaling consistently (e.g., high traffic rate), continually utilizing the second procedure may incur more latency during the high traffic rate than if the UE 115-a used the first procedure during the high traffic rate and vice versa.

As described herein, a UE 115-a may adaptively select a procedure for entering a sleep mode. In some examples, the UE 115-a may include a sleep operations manager 210 and utilize the sleep operations manager 210 to select the procedure for entering the sleep mode based on one or more operating parameters for the UE 115-a. In some examples, the one or more parameters may include a first statistic associated with receiving page signaling intended for the UE 115-a or a second statistic associated with receiving page signaling not intended for the UE 115-a. In some examples, the first statistic or the second statistic may be a fraction. For example, the first statistic may be a number of times the UE 115-a receives page signaling intended for the UE 115-a over a number of DRX cycles and the second statistic may be a number of times the UE 115-a receives page signaling not intended for the UE 115-a over a number of DRX cycles. If the first statistic is above a first threshold and/or if the second statistic is below a second threshold, the UE 115-a may select the first procedure for entering the sleep mode. Alternatively, if the first statistic is below the first threshold and/or if the second statistic is above the second threshold, the UE 115-a may select the second procedure for entering the sleep mode. In some examples, the UE 115-a may utilize other statistics (e.g., different from fractions) for selecting the procedure such as percentiles or finite-impulse-response (FIR) filter coefficients.

In another example, the UE 115-a may leverage long-term cell history or time of day metrics to select the procedure for entering the sleeping mode. In some examples, the UE 115-a may track a page load during different times of the day and may also track a number of cells in a paging area and a number of UEs 115 per cell. From this, the UE 115-a may determine busy times of day and non-busy times of day. During the busy times of day, receiving signaling not intended for the UE 115-a may increase if the number of UEs 115 exceeds a threshold. As such, the UE 115-a may select the first procedure during busy times of day if the number of UEs 115 exceeds a threshold. Alternatively, the UE 115-a may select a second procedure during busy times of day if the number of UEs 115 is below the threshold.

Alternatively or additionally, the one or more operating parameters may include a power capability of the UE 115-a. If the UE 115-a is not power constrained (e.g., the UE 115-a is connected to an alternating current (AC) adaptor or a battery level of the UE 115-a is above a threshold), the UE 115-a may select the first procedure for entering the sleep mode. Alternatively, if the UE 115-a is power constrained, the UE 115-a may select the second procedure for entering the sleep mode. In another example, the UE 115-a may select the first procedure for entering the sleep mode if a power consumption at the UE 115-a is high (e.g., above a threshold). When the power consumption at the UE 115-a is high (e.g., due to data being rendered on a display of the UE 115-a), the power consumed by the UE 115-a by the use of the first procedure may be negligible or zero. In another example, the UE 115-a may be scheduled to perform measurements (e.g., intra-frequency measurements, inter-frequency measurements, or inter-rat measurements) after the first duration (e.g., after the paging opportunity). In such case, the UE 115-a may select the first procedure for entering the sleep mode.

Alternatively, or additionally, the one or more operating parameters may include a connectivity mode of the UE 115-a. In some examples, the UE 115-a may communicate data using a cellular connection or a non-cellular connection (e.g., Wifi). If the UE 115-a primarily uses a cellular connection to communicate data (e.g., the UE 115-a communicates more data over the cellular connection during a time period than the non-cellular connection), the UE 115-a may select the first procedure for entering the sleep mode. Alternatively, if the UE 115-a primarily uses the non-cellular connection to communicate data, the UE 115-a may select the second procedure.

Alternatively, or additionally, the one or more operating parameters may include a duration associated with a DRX cycle configured for the UE 115-a. In some examples, if a duration of the DRX cycle exceeds a threshold (e.g., 1.28 seconds), the UE 115-a may select the second procedure. Alternatively, if the duration of the DRX cycle does not exceeds the threshold, the UE may select the first procedure. Using the one or more operating parameters, the UE 115-a may select the procedure and perform the procedure during the following DRX cycle. Using such techniques may allow the UE 115-a to conserve power and reduce latency related to a sleep procedure by adapting the sleep procedure to the current conditions of the UE 115-a.

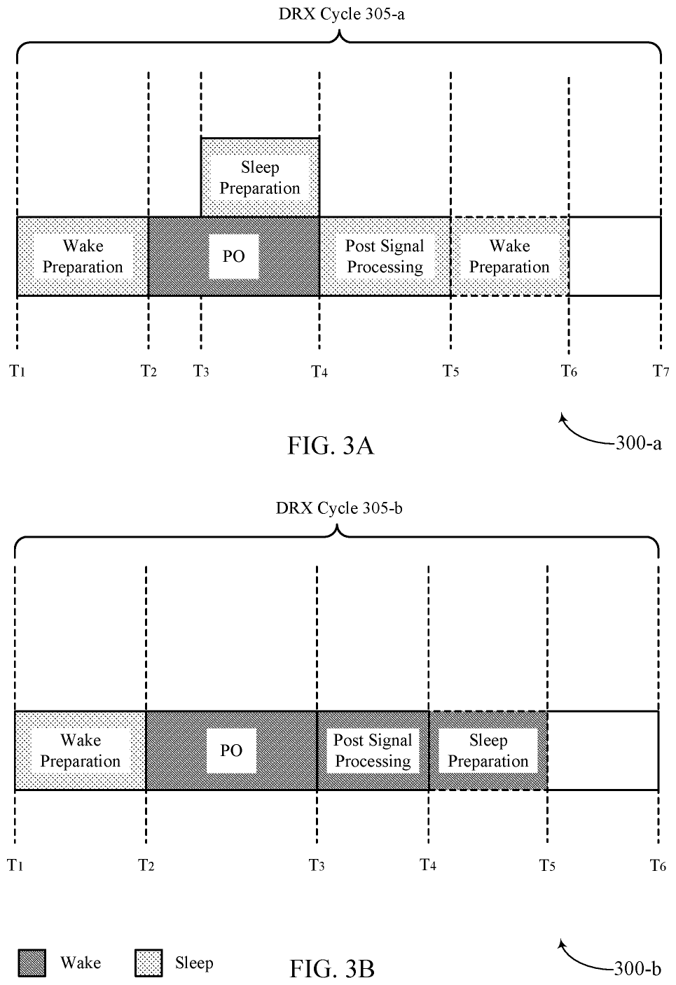

FIGS. 3A and 3B illustrate examples of a sleep procedure 300 (e.g., a sleep procedure 300-a and a sleep procedure 300-b) that supports adaptive selection of a sleep procedure in a wireless communications system in accordance with one or more aspects of the present disclosure. In some examples, the sleep procedure 300-a and the sleep procedure 300-b may be implemented by aspects of the wireless communications system 100 and the wireless communications system 200. For example, the sleep procedure 300-a and the sleep procedure 300-b may be implemented by a UE 115 as described with reference to FIGS. 1 and 2.

As described herein, a UE may select a procedure for entering a sleep mode based on one or more operating parameters of the UE. The set of procedures from which the UE may select from may include a first procedure and a second procedure. The first procedure may be known as an aggressive flow and may be illustrated in FIG. 3A. The second procedure may be known as a conservative flow and may be shown in FIG. 3B. The UE may select the procedure prior to a DRX cycle 305 and perform the selected procedure during the DRX cycle 305.

As illustrated in FIG. 3A, the UE may perform a wake preparation procedure beginning at T1 until T2. During the wake preparation procedure, the UE may be asleep. That is, baseband circuitry of the UE may be powered off. Beginning at T2 until T3, the UE may begin monitoring for page signaling. A duration from T2 to T4 may be known as a paging opportunity and during the duration from T2 to T4, the UE may be awake (e.g., based on performing the wake preparation procedure). That is, baseband circuitry of the UE may be powered on. In some examples, during the paging opportunity, the UE may perform a sleep preparation procedure. For example, the UE may perform the sleep preparation procedure beginning at T3 to T4. From T4 to T5, the UE may process the page signaling received during the paging opportunity and during a duration from T4 to T5, the UE may be asleep. In some examples, the UE may receive page signaling intended for the UE during the paging opportunity (e.g., receive downlink control information (DCI) intended for the UE) and as such, may decode the page signaling. In such example, the UE may perform a wakeup procedure beginning from T5 until T6. During the wakeup procedure, the UE may be asleep. From T6 to T7, the UE may be awake and transmit or receive signaling according to the received page signaling. Alternatively, the UE may not receive page signaling intended for the UE during the paging opportunity and as such, may not decode the page signaling. In such example, the UE may not perform the wake preparation procedure and instead, may stay asleep from T6 to T7.

As illustrated in FIG. 3B, the UE may perform a wake preparation procedure beginning at T1 until T2. During the wake preparation procedure, the UE may be asleep. That is, baseband circuitry of the UE may be powered off. Beginning at T2 until T3, the UE may begin monitoring for page signaling. A duration from T2 to T3 may be known as a paging opportunity and during the duration from T2 to T3, the UE may be awake (e.g., based on performing the wake preparation procedure). That is, baseband circuitry of the UE may be powered on. From T3 to T4, the UE may process the page signaling received during the paging opportunity and during a duration from T3 to T4, the UE may be awake. In some examples, the UE may not receive page signaling intended for the UE during the paging opportunity (e.g., receive DCI intended for the UE) and as such, may not decode the page signaling. In such example, the UE may perform a sleep preparation procedure beginning from T4 until T5. During the sleep preparation procedure, the UE may be awake. From T5 to T6, the UE may stay asleep. Alternatively, the UE may receive page signaling intended for the UE during the paging opportunity and as such, may decode the page signaling. In such example, the UE may not perform the sleep preparation procedure, but instead, from T4 to T6, the UE may be awake and may transmit or receive signaling based on the received page signaling.

The UE may select between the first procedure (e.g., as described in FIG. 3A) or select the second procedure (e.g., as described in FIG. 3B) based on one or more operating parameters of the UE. The one or more operating parameters may include a first statistic associated with receiving page signaling intended for the UE, a second statistic associated with receiving page signaling not intended for the UE, a power capability of the UE, a connectivity mode of the UE, or a duration associated with a DRX cycle configured for the UE. As one example, the UE may select the first procedure if the primarily communicates with the network via a non-cellular connection as opposed to a cellular connection. As another example, the UE may select the second procedure if the UE is not power constrained.

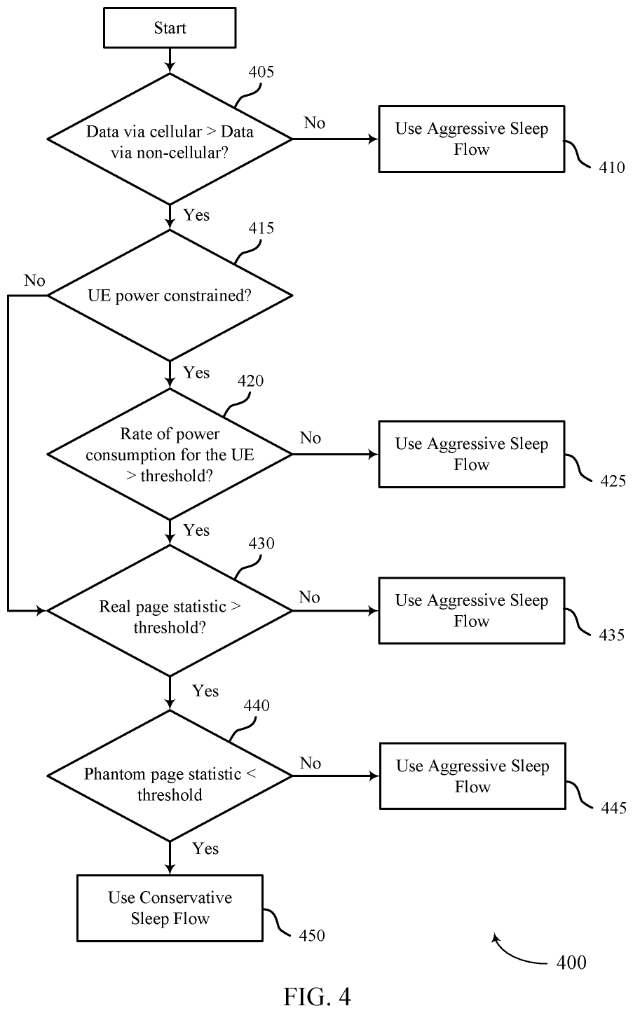

FIG. 4 illustrates an example of a flow diagram 400 that supports adaptive selection of a sleep procedure in a wireless communications system in accordance with one or more aspects of the present disclosure. In some examples, the wireless communications system 200 may be implemented by aspects of a wireless communications system 100 and a wireless communications system 200. For example, the flow diagram may be implemented by a UE 115 as described with reference to FIGS. 1 and 2. In some cases, alternative examples of the following may be implemented, where some operations may be performed in a different order than described or are not performed at all. Additionally or alternatively, operations may include additional features not mentioned below, or further processes may be added.

At 405, a UE may determine whether data communicated via a cellular connection is greater than data communicated via a non-cellular connection. That is, the UE may determine whether the UE has Internet Protocol (IP) data connectivity on wireless wide area network (WWAN) or Wifi as the primary connection. If the data communicated via the cellular connection is greater than the data communicated via the non-cellular connection, the UE may proceed to 415. If the data communicated via the cellular connection is less than the data communicated via the non-cellular connection, the UE may proceed to 410. In some examples, if the UE has both a non-cellular connection and a cellular connection, the UE may offload all internet traffic (e.g., internet data traffic or IMS voice services) on the non-cellular connection. In such case, the UE may proceed to 410.

At 410, the UE may enter a sleep mode using an aggressive flow. That is, after a paging opportunity of a DRX cycle, the UE may enter the sleep mode for a duration. During the duration, the UE may attempt to decode page signaling received during the paging opportunity.

At 415, the UE may determine whether the UE is power constrained. The UE may be considered power constrained if the UE is not connected to a AC adaptor or if a battery level of the UE is low (e.g., below a threshold). If the UE determined that the UE is power constrained, the UE may proceed to 420. If the UE determined that the UE is not power constrained, the UE may proceed to 430.

At 420, the UE may determine whether a rate of power consumption for the UE is high (e.g., above a threshold). In some examples, the rate of power consumption may be high if the UE's display running or if an application at the UE is running. If the rate of power consumption for the UE is high, a rate of power consumption due to using a conservative flow to enter the sleep mode may be negligible or zero. That is, the rate of power consumption using the conservative flow versus the total rate of power consumption for the UE may be very small (e.g., less than a threshold). The conservative flow may consume more power than the aggressive sleep flow. Using the conservative sleep flow, the UE may stay awake a duration after the paging opportunity. During the duration, the UE may attempt to decode page signaling received during the paging opportunity. If the UE determine that the rate of power consumption for the UE is high, the UE may proceed to 430. If the UE determines the rate of power consumption for the UE is low (e.g., below a threshold), the UE may proceed to 425.

At 425, the UE may enter the sleep mode using the aggressive flow.

At 430, the UE may determine whether a statistic associated with receiving page signaling intended for the UE (e.g., a real page statistic) exceeds a threshold. In some examples, after each DRX cycle, the UE may determine if the UE received page signaling intended for the UE during the paging opportunity of the DRX cycle. If the UE receives page signaling intended for the UE, the UE may increment a first counter (e.g., real page counter). Additionally, after each DRX cycle, the UE may increment a second counter (e.g., a DRX cycle counter). To determine the statistic associated with receiving the page signaling intended for the UE, the UE may divide the first counter by the second counter resulting in a fraction or percentage. If the UE determines that the statistic (e.g., the fraction or percentage) exceeds the threshold, the UE may proceed to 440. If the UE determines that the statistic is below the threshold, the UE may proceed to 435.

At 435, the UE may enter the sleep mode using the aggressive flow.

At 440, the UE may determine whether a statistic associated with receiving page signaling not intended for the UE (e.g., a phantom page statistic) exceeds a threshold. In some examples, after each DRX cycle, the UE may determine if the UE received page signaling intended for the UE during the paging opportunity of the DRX cycle. If the UE does not receive page signaling intended for the UE, the UE may increment a third counter (e.g., a phantom page counter). Additionally, after each DRX cycle, the UE may increment a fourth counter (e.g., a DRX cycle counter). To determine the statistic associated with receiving the page signaling not intended for the UE, the UE may divide the third counter by the fourth counter resulting in a fraction or percentage. If the UE determines that the statistic (e.g., the fraction or percentage) exceeds the threshold, the UE may proceed to 450. If the UE determines that the statistic is below the threshold, the UE may proceed to 445.

At 445, the UE may enter the sleep mode using the aggressive flow.

At 450, the UE may enter the sleep mode using the conservative flow.

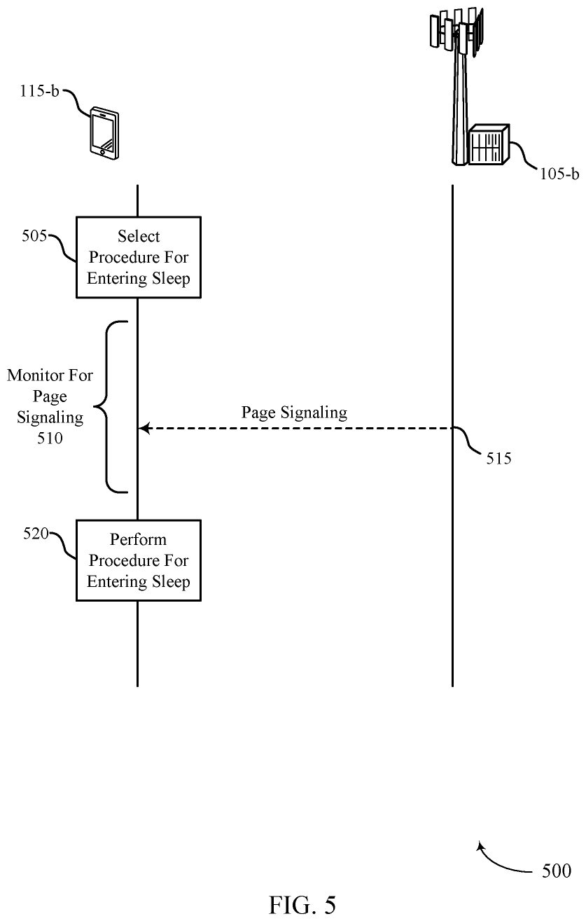

FIG. 5 illustrates an example of a process flow 500 that supports adaptive selection of a sleep procedure in a wireless communications system in accordance with one or more aspects of the present disclosure. In some examples, the process flow 500 may be implemented by aspects of a wireless communications system 100 and a wireless communications system 200. For example, the process flow 500 may be implemented by a base station 105 and a UE 115 as described with reference to FIGS. 1 and 2. Alternative examples of the following may be implemented, where some steps are performed in a different order then described or are not performed at all. In some cases, steps may include additional features not mentioned below, or further steps may be added.

At 505, a UE 115-b may select a procedure for entering a sleep mode. In some examples, the UE may select the procedure for entering the sleep mode from a set of procedures for entering the sleep mode. The set of procedure for the entering the sleep mode may include a first procedure and a second procedure. In some examples, the first procedure may be known as an aggressive flow and the second procedure may be known as a conservative flow.

In some cases, the UE 115-b may select the procedure for entering the sleep mode based on one or more operating characteristics for the UE 115-b. The one or more operating characteristics may include one or more of a statistic associated with receiving page signaling intended for the UE 115-b, a statistic associated with receiving page signaling not intended for the UE 115-b, a connectivity mode of the UE 115-b, a power capability of the UE 115-b, a rate of power consumption for the UE 115-b, a duration associated with a DRX cycle configured for the UE 115-b, or any combination thereof. In some examples, the UE 115-b may select the second procedure based on determining that the statistic associated with receiving page signaling intended for the UE 115-b is above a first threshold. Alternatively or additionally, the UE 115-b may select the second procedure based on determining that the statistic associated with the receiving the page signaling not intended for the UE 115-b is below a second threshold.

Additionally or alternatively, the UE 115-b may select the second procedure based on determining that the UE 115-b communicates more data via a cellular connection than a non-cellular connection. Additionally or alternatively, the UE 115-b may select the second procedure based on the UE 115-b determining that the UE 115-b is not power constrained (e.g., battery level of the UE 115-b is above a threshold or the UE 115-b is connected to an AC adaptor). In another example, the UE may select the second procedure based on the UE 115-b determining that the rate of power consumption of the UE 115-b is above a threshold. Additionally or alternatively, the UE 115-b may select the first procedure based on the UE determining that the duration associated with the DRX cycle exceeds a threshold.

At 510, the UE 115-b may monitor for page signaling from the base station 105-b during a time period. In some examples, the time period may be known as a paging opportunity.

At 515, the UE 115-b may potentially receive page signaling from the base station 105-b during the time period. In some examples, the page signaling may be intended for the UE 115-b. That is, the page signaling may be addressed with an ID (e.g., NG-5G-S-TMSI) recognizable (e.g., assigned) to the UE 115-b. Alternatively, the page signaling may not be intended for the UE 115-b. That is, the paging signaling may not be addressed to the ID recognizable to the UE 115-b.

At 520, the UE 115-b may perform the procedure selected at 505. In one example, the UE 115-b may select the first procedure. In such case, the UE 115-b may deactivate baseband circuitry of the UE 115-b a first duration after the time period. After deactivating the baseband circuitry, the UE 115-b may attempt to decode the UE 115-b. In another example, the UE 115-b may deactivate baseband circuitry of the UE 115-b a second duration after the time period (e.g., if the UE 115-b does not receive page signaling intended for the UE 115-b. In some examples, the second duration may be longer than the first duration. During at least a portion of the second duration, the UE 115-b may decode the page signaling potentially received from the base station 105-b at 515.

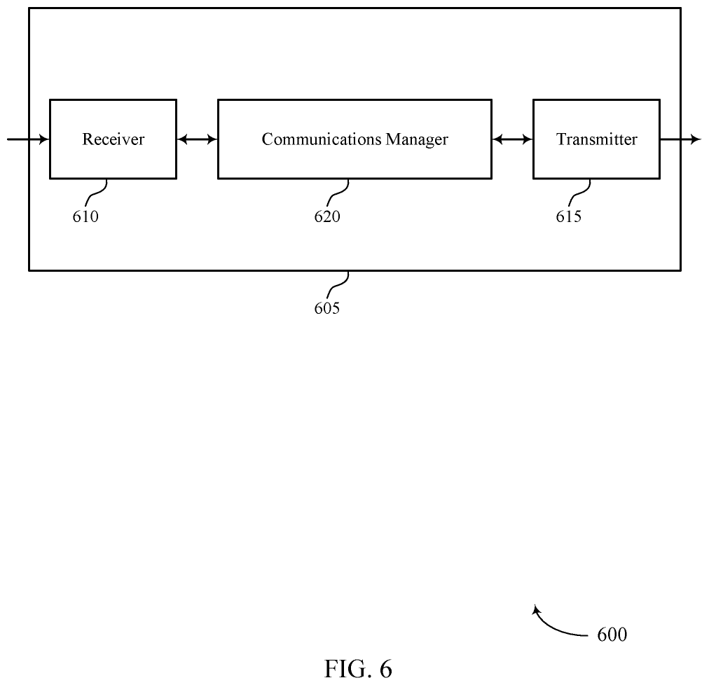

FIG. 6 shows a block diagram 600 of a device 605 that supports adaptive selection of a sleep procedure in a wireless communications system in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to adaptive selection of a sleep procedure in a wireless communications system). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to adaptive selection of a sleep procedure in a wireless communications system). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of adaptive selection of a sleep procedure in a wireless communications system as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communication at a UE in accordance with examples as disclosed herein. For example, the communications manager 620 may be configured as or otherwise support a means for selecting, based on one or more operating characteristics for the UE, a procedure for entering a sleep mode from among a set of procedures for entering the sleep mode, where the set of procedures includes a first procedure for entering the sleep mode and a second procedure for entering the sleep mode. The communications manager 620 may be configured as or otherwise support a means for monitoring, after selecting the procedure for entering the sleep mode, for page signaling for the UE during a time period. The communications manager 620 may be configured as or otherwise support a means for performing the selected procedure for entering the sleep mode, where the first procedure for entering the sleep mode includes deactivating baseband circuitry of the UE a first duration after the time period and the second procedure for entering the sleep mode includes deactivating the baseband circuitry of the UE a second duration after the time period, the second duration longer than the first duration.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for reduced power consumption.

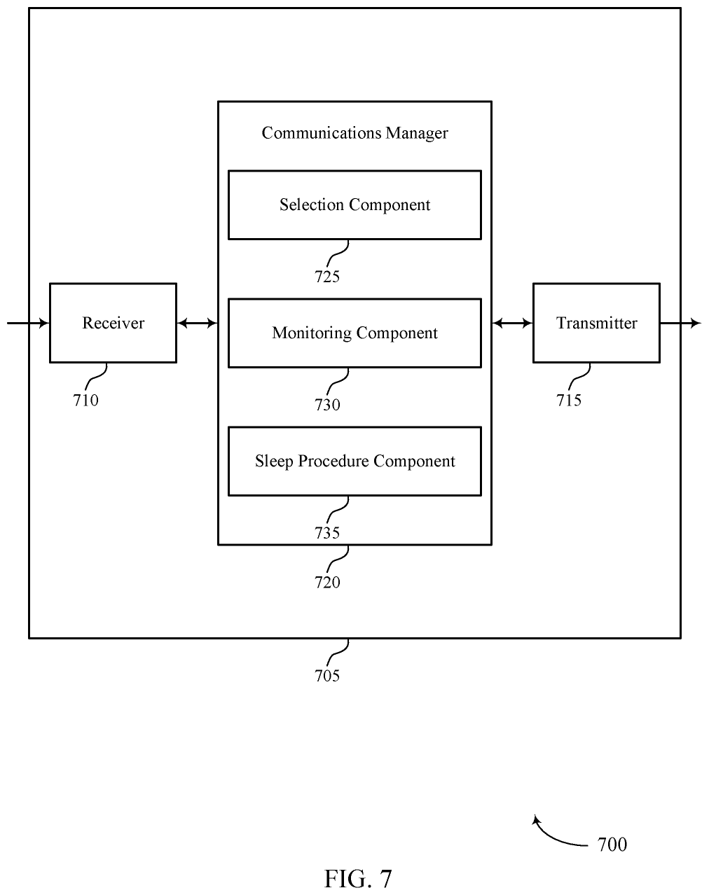

FIG. 7 shows a block diagram 700 of a device 705 that supports adaptive selection of a sleep procedure in a wireless communications system in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to adaptive selection of a sleep procedure in a wireless communications system). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to adaptive selection of a sleep procedure in a wireless communications system). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of adaptive selection of a sleep procedure in a wireless communications system as described herein. For example, the communications manager 720 may include a selection component 725, a monitoring component 730, a sleep procedure component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication at a UE in accordance with examples as disclosed herein. The selection component 725 may be configured as or otherwise support a means for selecting, based on one or more operating characteristics for the UE, a procedure for entering a sleep mode from among a set of procedures for entering the sleep mode, where the set of procedures includes a first procedure for entering the sleep mode and a second procedure for entering the sleep mode. The monitoring component 730 may be configured as or otherwise support a means for monitoring, after selecting the procedure for entering the sleep mode, for page signaling for the UE during a time period. The sleep procedure component 735 may be configured as or otherwise support a means for performing the selected procedure for entering the sleep mode, where the first procedure for entering the sleep mode includes deactivating baseband circuitry of the UE a first duration after the time period and the second procedure for entering the sleep mode includes deactivating the baseband circuitry of the UE a second duration after the time period, the second duration longer than the first duration.

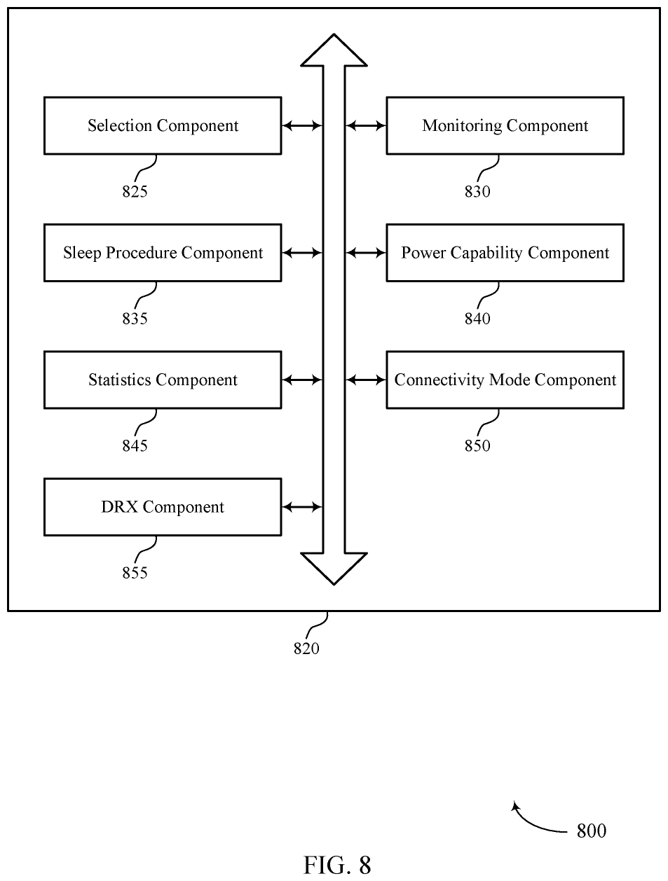

FIG. 8 shows a block diagram 800 of a communications manager 820 that supports adaptive selection of a sleep procedure in a wireless communications system in accordance with one or more aspects of the present disclosure. The communications manager 820 may be an example of aspects of a communications manager 620, a communications manager 720, or both, as described herein. The communications manager 820, or various components thereof, may be an example of means for performing various aspects of adaptive selection of a sleep procedure in a wireless communications system as described herein. For example, the communications manager 820 may include a selection component 825, a monitoring component 830, a sleep procedure component 835, a power capability component 840, a statistics component 845, a connectivity mode component 850, a DRX component 855, or any combination thereof. Each of these components may communicate, directly or indirectly, with one another (e.g., via one or more buses).

The communications manager 820 may support wireless communication at a UE in accordance with examples as disclosed herein. The selection component 825 may be configured as or otherwise support a means for selecting, based on one or more operating characteristics for the UE, a procedure for entering a sleep mode from among a set of procedures for entering the sleep mode, where the set of procedures includes a first procedure for entering the sleep mode and a second procedure for entering the sleep mode. The monitoring component 830 may be configured as or otherwise support a means for monitoring, after selecting the procedure for entering the sleep mode, for page signaling for the UE during a time period. The sleep procedure component 835 may be configured as or otherwise support a means for performing the selected procedure for entering the sleep mode, where the first procedure for entering the sleep mode includes deactivating baseband circuitry of the UE a first duration after the time period and the second procedure for entering the sleep mode includes deactivating the baseband circuitry of the UE a second duration after the time period, the second duration longer than the first duration.

In some examples, the one or more operating characteristics include a statistic associated with receiving page signaling intended for the UE, a statistic associated with receiving page signaling not intended for the UE, a connectivity mode associated with the UE, a power capability of the UE, a rate of power consumption for the UE, a duration associated with a DRX cycle configured for the UE, or any combination thereof.

In some examples, the statistic associated with receiving page signaling intended for the UE include a fraction, the fraction indicating a number of times the UE received page signaling intended for the UE over a number of time periods.

In some examples, the statistic associated with receiving the page signaling not intended for the UE includes a fraction, the fraction indicating a number of times the UE received page signaling not intended for the UE over a number of time periods.

In some examples, the statistics component 845 may be configured as or otherwise support a means for determining whether the statistic associated with receiving page signaling intended for the UE is above a first threshold, whether the statistic associated with receiving page signaling not intended for the UE is below a second threshold, or both. In some examples, the selection component 825 may be configured as or otherwise support a means for selecting the second procedure for entering the sleep mode based on determining that the statistic associated with receiving page signaling intended for the UE is above the first threshold, that the statistic associated with receiving page signaling not intended for the UE is below the second threshold, or both. In some examples, the selection component 825 may be configured as or otherwise support a means for selecting the first procedure for entering the sleep mode based on determining that the statistic associated with receiving page signaling intended for the UE is below the first threshold, that the statistic associated with receiving page signaling not intended for the UE is above the second threshold, or both.

In some examples, the connectivity mode component 850 may be configured as or otherwise support a means for determining whether the UE communicates, within a second time period, more data via one or more cellular connections than one or more non-cellular connections (e.g., determining the connectivity mode for the UE). In some examples, the selection component 825 may be configured as or otherwise support a means for selecting the second procedure for entering the sleep mode based on determining that the UE communicates, within the second time period, more data via the one or more cellular connections than the one or more non-cellular connections. In some examples, the selection component 825 may be configured as or otherwise support a means for selecting the first procedure for entering the sleep mode based on determining that the UE communicates, within the time period, less data via the one or more cellular connections than the one or more non-cellular connections.

In some examples, the power capability component 840 may be configured as or otherwise support a means for determining whether the power capability of the UE satisfies a condition. In some examples, the selection component 825 may be configured as or otherwise support a means for selecting the second procedure for entering the sleep mode based on determining that the power capability of the UE satisfies the condition. In some examples, the selection component 825 may be configured as or otherwise support a means for selecting the first procedure for entering the sleep mode based on determining that the power capability of the UE does not satisfy the condition.

In some examples, to support determining whether the power capability of the UE satisfies the condition, the power capability component 840 may be configured as or otherwise support a means for determining whether a battery level associated with the UE is above a threshold. In some examples, to support determining whether the power capability of the UE satisfies the condition, the power capability component 840 may be configured as or otherwise support a means for determining whether the UE is connected to an AC adapter.

In some examples, the DRX component 855 may be configured as or otherwise support a means for determining whether a duration associated with the DRX cycle configured for the UE satisfies a threshold. In some examples, the DRX component 855 may be configured as or otherwise support a means for selecting the first procedure for entering the sleep mode based on determining that the duration associated with the DRX cycle configured for the UE satisfies the threshold. In some examples, the DRX component 855 may be configured as or otherwise support a means for selecting the second procedure for entering the sleep mode based on determining that the duration associated with the DRX cycle configured for the UE does not satisfy the threshold.

In some examples, the power capability component 840 may be configured as or otherwise support a means for determining whether a rate of power consumption for the UE satisfies a threshold. In some examples, the selection component 825 may be configured as or otherwise support a means for selecting the second procedure for entering the sleep mode based on determining that the rate of power consumption for the UE satisfies the threshold. In some examples, the selection component 825 may be configured as or otherwise support a means for selecting the first procedure for entering the sleep mode based on determining that the rate of power consumption for the UE does not satisfy the threshold.

In some examples, the selected procedure for entering the sleep mode includes the second procedure, and the sleep procedure component 835 may be configured as or otherwise support a means for attempting to decode the page signaling during at least a portion of the second duration, where deactivating the baseband circuitry is based on failing to decode the page signaling during at least the portion of the second duration.

In some examples, the selected procedure for entering the sleep mode includes the first procedure, and the sleep procedure component 835 may be configured as or otherwise support a means for attempting to decode the page signaling after deactivating the baseband circuitry.

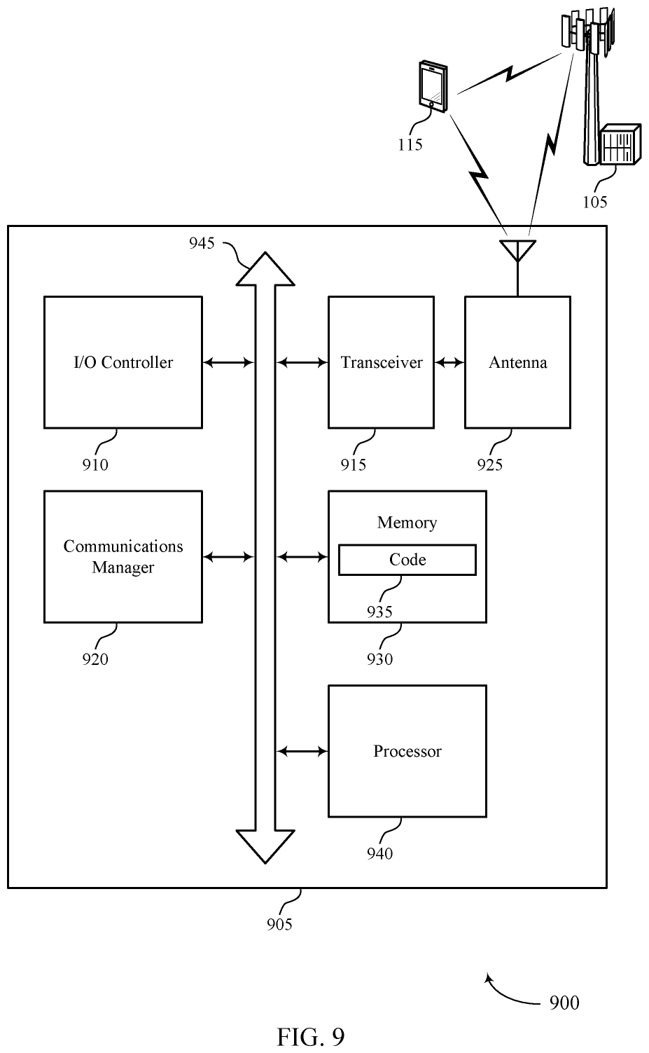

FIG. 9 shows a diagram of a system 900 including a device 905 that supports adaptive selection of a sleep procedure in a wireless communications system in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting adaptive selection of a sleep procedure in a wireless communications system). For example, the device 905 or a component of the device 905 may include a processor 940 and memory 930 coupled with or to the processor 940, the processor 940 and memory 930 configured to perform various functions described herein.

The communications manager 920 may support wireless communication at a UE in accordance with examples as disclosed herein. For example, the communications manager 920 may be configured as or otherwise support a means for selecting, based on one or more operating characteristics for the UE, a procedure for entering a sleep mode from among a set of procedures for entering the sleep mode, where the set of procedures includes a first procedure for entering the sleep mode and a second procedure for entering the sleep mode. The communications manager 920 may be configured as or otherwise support a means for monitoring, after selecting the procedure for entering the sleep mode, for page signaling for the UE during a time period. The communications manager 920 may be configured as or otherwise support a means for performing the selected procedure for entering the sleep mode, where the first procedure for entering the sleep mode includes deactivating baseband circuitry of the UE a first duration after the time period and the second procedure for entering the sleep mode includes deactivating the baseband circuitry of the UE a second duration after the time period, the second duration longer than the first duration.

By including or configuring the communications manager 920 in accordance with examples as described herein, the device 905 may support techniques for reduced latency and reduced power consumption.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of adaptive selection of a sleep procedure in a wireless communications system as described herein, or the processor 940 and the memory 930 may be otherwise configured to perform or support such operations.

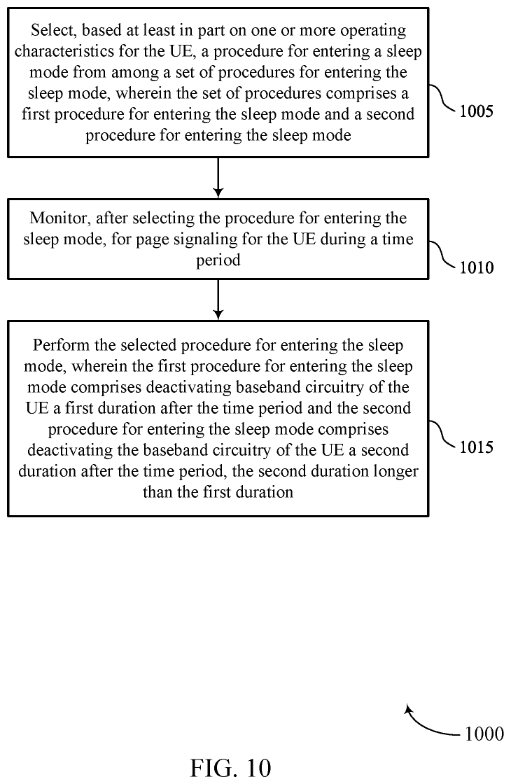

FIG. 10 shows a flowchart illustrating a method 1000 that supports adaptive selection of a sleep procedure in a wireless communications system in accordance with one or more aspects of the present disclosure. The operations of the method 1000 may be implemented by a UE or its components as described herein. For example, the operations of the method 1000 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1005, the method may include selecting, based on one or more operating characteristics for the UE, a procedure for entering a sleep mode from among a set of procedures for entering the sleep mode, where the set of procedures includes a first procedure for entering the sleep mode and a second procedure for entering the sleep mode. The operations of 1005 may be performed in accordance with examples as disclosed herein. In some examples, aspects of the operations of 1005 may be performed by a selection component 825 as described with reference to FIG. 8. Additionally or alternatively, means for performing 1005 may, but not necessarily, include, for example, antenna 925, transceiver 915, communications manager 920, memory 930 (including code 935), processor 940 and/or bus 945.

At 1010, the method may include monitoring, after selecting the procedure for entering the sleep mode, for page signaling for the UE during a time period. The operations of 1010 may be performed in accordance with examples as disclosed herein. In some examples, aspects of the operations of 1010 may be performed by a monitoring component 830 as described with reference to FIG. 8. Additionally or alternatively, means for performing 1010 may, but not necessarily, include, for example, antenna 925, transceiver 915, communications manager 920, memory 930 (including code 935), processor 940 and/or bus 945.

At 1015, the method may include performing the selected procedure for entering the sleep mode, where the first procedure for entering the sleep mode includes deactivating baseband circuitry of the UE a first duration after the time period and the second procedure for entering the sleep mode includes deactivating the baseband circuitry of the UE a second duration after the time period, the second duration longer than the first duration. The operations of 1015 may be performed in accordance with examples as disclosed herein. In some examples, aspects of the operations of 1015 may be performed by a sleep procedure component 835 as described with reference to FIG. 8. Additionally or alternatively, means for performing 1015 may, but not necessarily, include, for example, antenna 925, transceiver 915, communications manager 920, memory 930 (including code 935), processor 940 and/or bus 945.

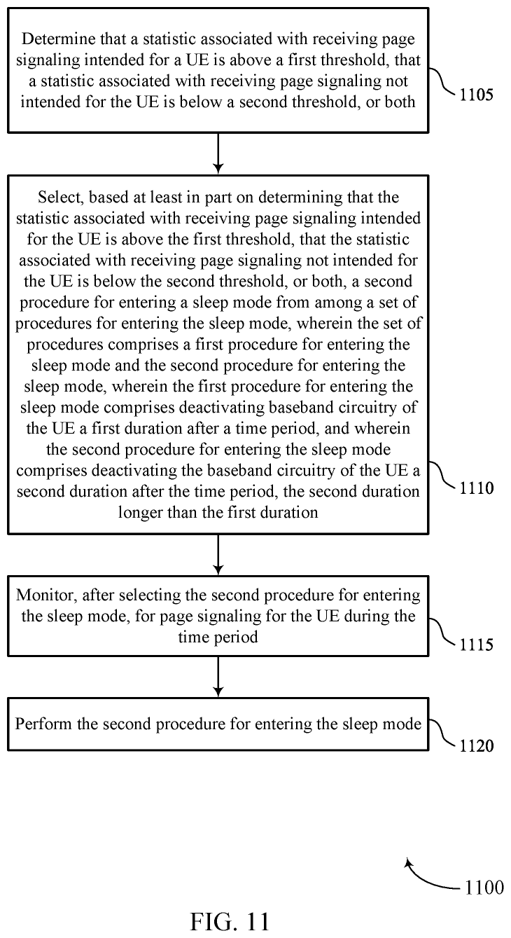

FIG. 11 shows a flowchart illustrating a method 1100 that supports adaptive selection of a sleep procedure in a wireless communications system in accordance with one or more aspects of the present disclosure. The operations of the method 1100 may be implemented by a UE or its components as described herein. For example, the operations of the method 1100 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1105, the method may include determining that a statistic associated with receiving page signaling intended for the UE is above a first threshold, that a statistic associated with receiving page signaling not intended for the UE is below a second threshold, or both. The operations of 1105 may be performed in accordance with examples as disclosed herein. In some examples, aspects of the operations of 1105 may be performed by a statistics component 845 as described with reference to FIG. 8. Additionally or alternatively, means for performing 1105 may, but not necessarily, include, for example, antenna 925, transceiver 915, communications manager 920, memory 930 (including code 935), processor 940 and/or bus 945.

At 1110, the method may include selecting, based on determining that the statistic associated with receiving page signaling intended for the UE is above the first threshold, that the statistic associated with receiving page signaling not intended for the UE is below the second threshold, or both, a second procedure for entering a sleep mode from among a set of procedures for entering the sleep mode. The set of procedures may include a first procedure for entering the sleep mode and the second procedure for entering the sleep mode, where the first procedure for entering the sleep mode may include deactivating baseband circuitry of the UE a first duration after a time period, and where the second procedure for entering the sleep mode may include deactivating the baseband circuitry of the UE a second duration after the time period, the second duration longer than the first duration. The operations of 1110 may be performed in accordance with examples as disclosed herein. In some examples, aspects of the operations of 1110 may be performed by a selection component 825 as described with reference to FIG. 8. Additionally or alternatively, means for performing 1110 may, but not necessarily, include, for example, antenna 925, transceiver 915, communications manager 920, memory 930 (including code 935), processor 940 and/or bus 945.

At 1115, the method may include monitoring, after selecting the second procedure for entering the sleep mode, for page signaling for the UE during the time period. The operations of 1115 may be performed in accordance with examples as disclosed herein. In some examples, aspects of the operations of 1115 may be performed by a monitoring component 830 as described with reference to FIG. 8. Additionally or alternatively, means for performing 1115 may, but not necessarily, include, for example, antenna 925, transceiver 915, communications manager 920, memory 930 (including code 935), processor 940 and/or bus 945.

At 1120, the method may include performing the second procedure for entering the sleep mode. The operations of 1120 may be performed in accordance with examples as disclosed herein. In some examples, aspects of the operations of 1120 may be performed by a sleep procedure component 835 as described with reference to FIG. 8. Additionally or alternatively, means for performing 1120 may, but not necessarily, include, for example, antenna 925, transceiver 915, communications manager 920, memory 930 (including code 935), processor 940 and/or bus 945.

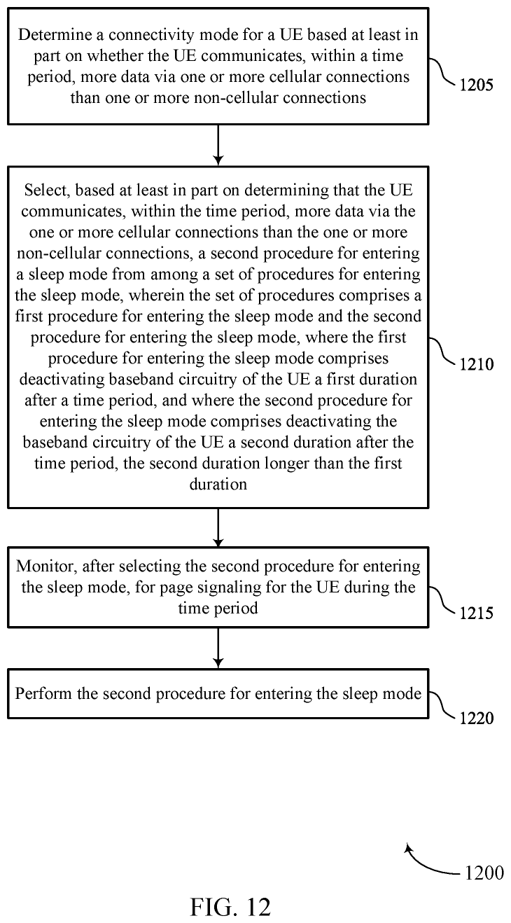

FIG. 12 shows a flowchart illustrating a method 1200 that supports adaptive selection of a sleep procedure in a wireless communications system in accordance with one or more aspects of the present disclosure. The operations of the method 1200 may be implemented by a UE or its components as described herein. For example, the operations of the method 1200 may be performed by a UE 115 as described with reference to FIGS. 1 through 9. In some examples, a UE may execute a set of instructions to control the functional elements of the UE to perform the described functions. Additionally, or alternatively, the UE may perform aspects of the described functions using special-purpose hardware.

At 1205, the method may include determining a connectivity mode for the UE based on whether the UE communicates, within a second time period, more data via one or more cellular connections than one or more non-cellular connections. The operations of 1205 may be performed in accordance with examples as disclosed herein. In some examples, aspects of the operations of 1205 may be performed by a connectivity mode component 850 as described with reference to FIG. 8. Additionally or alternatively, means for performing 1205 may, but not necessarily, include, for example, antenna 925, transceiver 915, communications manager 920, memory 930 (including code 935), processor 940 and/or bus 945.

At 1210, the method may include selecting, based on determining that the UE communicates, within the second time period, more data via the one or more cellular connections than the one or more non-cellular connections, a second procedure for entering a sleep mode from among a set of procedures for entering the sleep mode. The set of procedures may include a first procedure for entering the sleep mode and the second procedure for entering the sleep mode, where the first procedure for entering the sleep mode may include deactivating baseband circuitry of the UE a first duration after a time period, and where the second procedure for entering the sleep mode may include deactivating the baseband circuitry of the UE a second duration after the time period, the second duration longer than the first duration. The operations of 1210 may be performed in accordance with examples as disclosed herein. In some examples, aspects of the operations of 1210 may be performed by a selection component 825 as described with reference to FIG. 8. Additionally or alternatively, means for performing 1210 may, but not necessarily, include, for example, antenna 925, transceiver 915, communications manager 920, memory 930 (including code 935), processor 940 and/or bus 945.

At 1215, the method may include monitoring, after selecting the second procedure for entering the sleep mode, for page signaling for the UE during a time period. The operations of 1215 may be performed in accordance with examples as disclosed herein. In some examples, aspects of the operations of 1215 may be performed by a monitoring component 830 as described with reference to FIG. 8. Additionally or alternatively, means for performing 1215 may, but not necessarily, include, for example, antenna 925, transceiver 915, communications manager 920, memory 930 (including code 935), processor 940 and/or bus 945.

At 1220, the method may include performing the second procedure for entering the sleep mode. The operations of 1220 may be performed in accordance with examples as disclosed herein. In some examples, aspects of the operations of 1220 may be performed by a sleep procedure component 835 as described with reference to FIG. 8. Additionally or alternatively, means for performing 1220 may, but not necessarily, include, for example, antenna 925, transceiver 915, communications manager 920, memory 930 (including code 935), processor 940 and/or bus 945.

The following provides an overview of aspects of the present disclosure:

Aspect 1: A method for wireless communication at a UE, comprising: selecting, based at least in part on one or more operating characteristics for the UE, a procedure for entering a sleep mode from among a set of procedures for entering the sleep mode, wherein the set of procedures comprises a first procedure for entering the sleep mode and a second procedure for entering the sleep mode; monitoring, after selecting the procedure for entering the sleep mode, for page signaling for the UE during a time period; and performing the selected procedure for entering the sleep mode, wherein: the first procedure for entering the sleep mode comprises deactivating baseband circuitry of the UE a first duration after the time period; and the second procedure for entering the sleep mode comprises deactivating the baseband circuitry of the UE a second duration after the time period, the second duration longer than the first duration.

Aspect 2: The method of aspect 1, wherein the one or more operating characteristics comprise a statistic associated with receiving page signaling intended for the UE, a statistic associated with receiving page signaling not intended for the UE, a connectivity mode associated with the UE, a power capability of the UE, a rate of power consumption for the UE, a duration associated with a DRX configured for the UE, or any combination thereof.

Aspect 3: The method of aspect 2, wherein the statistic associated with receiving page signaling intended for the UE comprises a fraction, the fraction indicating a number of times the UE received page signaling intended for the UE over a number of time periods.

Aspect 4: The method of any of aspects 2 through 3, wherein the statistic associated with receiving the page signaling not intended for the UE comprises a fraction, the fraction indicating a number of times the UE received page signaling not intended for the UE over a number of time periods.

Aspect 5: The method of any of aspects 1 through 4, further comprising: determining whether a statistic associated with receiving page signaling intended for the UE is above a first threshold, whether a statistic associated with receiving page signaling not intended for the UE is below a second threshold, or both, wherein selecting the procedure for entering the sleep mode based at least in part on the one or more operating characteristics for the UE comprises: selecting the second procedure for entering the sleep mode based at least in part on determining that the statistic associated with receiving page signaling intended for the UE is above the first threshold, that the statistic associated with receiving page signaling not intended for the UE is below the second threshold, or both.

Aspect 6: The method of any of aspects 1 through 5, further comprising: determining whether the UE communicates, within a second time period, more data via one or more cellular connections than one or more non-cellular connections, wherein selecting a procedure for entering the sleep mode based at least in part on the one or more operating characteristics for the UE comprises: selecting the second procedure for entering the sleep mode based at least in part on determining that the UE communicates, within the second time period, more data via the one or more cellular connections than the one or more non-cellular connections.

Aspect 7: The method of any of aspects 1 through 6, further comprising: determining whether a power capability of the UE satisfies a condition, wherein selecting the procedure for entering the sleep mode based at least in part on the one or more operating characteristics for the UE comprises: selecting the second procedure for entering the sleep mode based at least in part on determining that the power capability of the UE satisfies the condition.

Aspect 8: The method of aspect 7, wherein determining whether the power capability of the UE satisfies the condition comprises: determining whether a battery level associated with the UE is above a threshold; or determining whether the UE is connected to an alternating current adapter.

Aspect 9: The method of any of aspects 1 through 8, further comprising: determining whether a duration associated with a DRX configured for the UE satisfies a threshold, wherein selecting the procedure for entering the sleep mode based at least in part on the one or more operating characteristics for the UE comprises: selecting the first procedure for entering the sleep mode based at least in part on determining that the duration associated with the DRX configured for the UE satisfies the threshold.

Aspect 10: The method of any of aspects 1 through 9, further comprising: determining whether a rate of power consumption for the UE satisfies a threshold, wherein selecting the procedure for entering the sleep mode based at least in part on the one or more operating characteristics for the UE comprises: selecting the second procedure for entering the sleep mode based at least in part on determining that the rate of power consumption for the UE satisfies the threshold.

Aspect 11: The method of any of aspects 1 through 10, wherein the selected procedure for entering the sleep mode comprises the second procedure, the method further comprising: attempting to decode the page signaling during at least a portion of the second duration, wherein deactivating the baseband circuitry is based at least in part on failing to decode the page signaling during at least the portion of the second duration.

Aspect 12: The method of any of aspects 1 through 10, wherein the selected procedure for entering the sleep mode comprises the first procedure, the method further comprising: attempting to decode the page signaling after deactivating the baseband circuitry.

Aspect 13: An apparatus for wireless communication at a UE, comprising a memory, a transceiver, and at least one processor coupled with the memory and the transceiver, the at least one processor configured to perform a method of any aspects 1 through 12.

Aspect 14: An apparatus for wireless communication at a UE, comprising at least one means for performing a method of any of aspects 1 through 12.

Aspect 15: A non-transitory computer-readable medium storing code for wireless communication at a UE, the code comprising instructions executable by a processor to perform a method of any of aspects 1 through 12.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communication at a user equipment (UE), comprising:
selecting, based at least in part on one or more operating characteristics for the UE, a procedure for entering a sleep mode from among a set of procedures for entering the sleep mode, wherein the set of procedures comprises a first procedure for entering the sleep mode and a second procedure for entering the sleep mode;
monitoring, after selecting the procedure for entering the sleep mode, for page signaling for the UE during a time period; and
performing the selected procedure for entering the sleep mode, wherein:
the first procedure for entering the sleep mode comprises deactivating baseband circuitry of the UE a first duration after the time period; and
the second procedure for entering the sleep mode comprises deactivating the baseband circuitry of the UE a second duration after the time period, the second duration longer than the first duration.

2. The method of claim 1, wherein the one or more operating characteristics comprise a statistic associated with receiving page signaling intended for the UE, a statistic associated with receiving page signaling not intended for the UE, a connectivity mode associated with the UE, a power capability of the UE, a rate of power consumption for the UE, a duration associated with a discontinuous reception cycle configured for the UE, or any combination thereof.

3. The method of claim 2, wherein the statistic associated with receiving page signaling intended for the UE comprises a fraction, the fraction indicating a number of times the UE received page signaling intended for the UE over a number of time periods.

4. The method of claim 2, wherein the statistic associated with receiving the page signaling not intended for the UE comprises a fraction, the fraction indicating a number of times the UE received page signaling not intended for the UE over a number of time periods.

5. The method of claim 1, further comprising:
determining whether a statistic associated with receiving page signaling intended for the UE is above a first threshold, whether a statistic associated with receiving page signaling not intended for the UE is below a second threshold, or both, wherein selecting the procedure for entering the sleep mode based at least in part on the one or more operating characteristics for the UE comprises:
selecting the second procedure for entering the sleep mode based at least in part on determining that the statistic associated with receiving page signaling intended for the UE is above the first threshold, that the statistic associated with receiving page signaling not intended for the UE is below the second threshold, or both.

6. The method of claim 1, further comprising:
determining whether the UE communicates, within a second time period, more data via one or more cellular connections than one or more non-cellular connections, wherein selecting a procedure for entering the sleep mode based at least in part on the one or more operating characteristics for the UE comprises:
selecting the second procedure for entering the sleep mode based at least in part on determining that the UE communicates, within the second time period, more data via the one or more cellular connections than the one or more non-cellular connections.

7. The method of claim 1, further comprising:
determining whether a power capability of the UE satisfies a condition, wherein selecting the procedure for entering the sleep mode based at least in part on the one or more operating characteristics for the UE comprises:
selecting the second procedure for entering the sleep mode based at least in part on determining that the power capability of the UE satisfies the condition.

8. The method of claim 7, wherein determining whether the power capability of the UE satisfies the condition comprises:
determining whether a battery level associated with the UE is above a threshold; or
determining whether the UE is connected to an alternating current adapter.

9. The method of claim 1, further comprising:
determining whether a duration associated with a discontinuous reception cycle configured for the UE satisfies a threshold, wherein selecting the procedure for entering the sleep mode based at least in part on the one or more operating characteristics for the UE comprises:
selecting the first procedure for entering the sleep mode based at least in part on determining that the duration associated with the discontinuous reception cycle configured for the UE satisfies the threshold.

10. The method of claim 1, further comprising:
determining whether a rate of power consumption for the UE satisfies a threshold, wherein selecting the procedure for entering the sleep mode based at least in part on the one or more operating characteristics for the UE comprises:
selecting the second procedure for entering the sleep mode based at least in part on determining that the rate of power consumption for the UE satisfies the threshold.

11. The method of claim 1, wherein the selected procedure for entering the sleep mode comprises the second procedure, the method further comprising:
attempting to decode the page signaling during at least a portion of the second duration, wherein deactivating the baseband circuitry is based at least in part on failing to decode the page signaling during at least the portion of the second duration.

12. The method of claim 1, wherein the selected procedure for entering the sleep mode comprises the first procedure, the method further comprising:
attempting to decode the page signaling after deactivating the baseband circuitry.

13. An apparatus for wireless communication at a user equipment (UE), comprising:
memory;
a transceiver; and
at least one processor of the UE, the at least one processor coupled with the memory and the transceiver, and the at least one processor configured to cause the apparatus to:
select, based at least in part on one or more operating characteristics for the UE, a procedure for entering a sleep mode from among a set of procedures for entering the sleep mode, wherein the set of procedures comprises a first procedure for entering the sleep mode and a second procedure for entering the sleep mode;
monitor, after selecting the procedure for entering the sleep mode, for page signaling for the UE during a time period; and
perform the selected procedure for entering the sleep mode, wherein:
the first procedure for entering the sleep mode comprises deactivating baseband circuitry of the UE a first duration after the time period; and
the second procedure for entering the sleep mode comprises deactivating the baseband circuitry of the UE a second duration after the time period, the second duration longer than the first duration.

14. The apparatus of claim 13, wherein the one or more operating characteristics comprise a statistic associated with receiving page signaling intended for the UE, a statistic associated with receiving page signaling not intended for the UE, a connectivity mode associated with the UE, a power capability of the UE, a rate of power consumption for the UE, a duration associated with a discontinuous reception cycle configured for the UE, or any combination thereof.

15. The apparatus of claim 13, wherein the at least one processor is further configured to cause the apparatus to:
determine whether a statistic associated with receiving page signaling intended for the UE is above a first threshold, whether a statistic associated with receiving page signaling not intended for the UE is below a second threshold, or both, wherein, to select the procedure for entering the sleep mode based at least in part on the one or more operating characteristics for the UE, the at least one processor is configured to cause the apparatus to:
select the second procedure for entering the sleep mode based at least in part on determining that the statistic associated with receiving page signaling intended for the UE is above the first threshold, that the statistic associated with receiving page signaling not intended for the UE is below the second threshold, or both.

16. The apparatus of claim 13, wherein the at least one processor is further configured to cause the apparatus to:
determine whether the UE communicates, within a second time period, more data via one or more cellular connections than one or more non-cellular connections, wherein, to select a procedure for entering the sleep mode based at least in part on the one or more operating characteristics for the UE, the at least one processor is configured to cause the apparatus to:
select the second procedure for entering the sleep mode based at least in part on determining that the UE communicates, within the second time period, more data via the one or more cellular connections than the one or more non-cellular connections.

17. The apparatus of claim 13, wherein the at least one processor is further configured to cause the apparatus to:
determine whether a power capability of the UE satisfies a condition, wherein, to select the procedure for entering the sleep mode based at least in part on the one or more operating characteristics for the UE, the at least one processor is configured to cause the apparatus to:
select the second procedure for entering the sleep mode based at least in part on determining that the power capability of the UE satisfies the condition.

18. The apparatus of claim 13, wherein the at least one processor is further configured to cause the apparatus to:
determine whether a duration associated with a discontinuous reception cycle configured for the UE satisfies a threshold, wherein, to select the procedure for entering the sleep mode based at least in part on the one or more operating characteristics for the UE, the at least one processor is configured to cause the apparatus to:
select the first procedure for entering the sleep mode based at least in part on determining that the duration associated with the discontinuous reception cycle configured for the UE satisfies the threshold.

19. The apparatus of claim 13, wherein the at least one processor is further configured to cause the apparatus to:
determine whether a rate of power consumption for the UE satisfies a threshold, wherein, to select the procedure for entering the sleep mode based at least in part on the one or more operating characteristics for the UE, the at least one processor is configured to cause the apparatus to:
select the second procedure for entering the sleep mode based at least in part on determining that the rate of power consumption for the UE satisfies the threshold.

20. A non-transitory computer-readable medium storing code for wireless communication at a user equipment (UE), the code comprising instructions executable by a processor to:
select, based at least in part on one or more operating characteristics for the UE, a procedure for entering a sleep mode from among a set of procedures for entering the sleep mode, wherein the set of procedures comprises a first procedure for entering the sleep mode and a second procedure for entering the sleep mode;
monitor, after selecting the procedure for entering the sleep mode, for page signaling for the UE during a time period; and
perform the selected procedure for entering the sleep mode, wherein:
the first procedure for entering the sleep mode comprises deactivating baseband circuitry of the UE a first duration after the time period; and
the second procedure for entering the sleep mode comprises deactivating the baseband circuitry of the UE a second duration after the time period, the second duration longer than the first duration.
